(19) United States
(12) Patent Application Publication
(10) Pub. No.: US 2014/0215508 A1
(43) Pub. Date: Jul. 31, 2014

(54) Distributing Graphic Content Over a Public Network for Inclusion in a Linear Television Broadcast

(71) Applicant: YOUTOO TECHNOLOGIES LLC, Las Colinas, TX (US)

(72) Inventors: Christopher W. Wyatt, Dallas, TX (US); Mark A. Harwell, Plano, TX (US); Danny Ohman, Flower Mound, TX (US); Ryland M. Reed, North Richland Hills, TX (US)

(73) Assignee: Youtoo Technologies LLC, Las Colinas, TX (US)

(21) Appl. No.: 13/750,126

(22) Filed: Jan. 25, 2013

(51) Int. Cl. H04N 21/475

(52) U.S. Cl. CPC H04N 21/4758
USPC 725/24; 725/32

(57) ABSTRACT

Methods, systems, and apparatus, including computer programs encoded on a computer storage medium, for receiving and distributing user-generated video content. In one aspect, a method includes receiving, via a network from a remote web server, a web page defining graphics data for presentation in a linear television broadcast. The received graphics data includes data defining one or more transparent regions. The method further includes compositing the received graphics data, based on the one or more transparent regions, with video from at least one other channel using a video switcher to form a composite video image, and transmitting the composite video image for distribution in a linear television broadcast.

### BACKGROUND

In producing and distributing a live or pre-recorded television program, television production and broadcast facilities utilize various pieces of complex and costly equipment. For example, for programs requiring composite feeds that include full motion video and graphic overlays, the production or broadcast facility may use a proprietary broadcast graphics system for generating, storing, and controlling the presentation of the graphic overlays within broadcasts, and a video switching system (such as a video switcher, video mixer or production switcher) to select between several different video sources and in some cases composite or mix video sources and graphic overlays together to create special effects. Generally, such broadcast graphics systems are expensive and require specialized expertise to operate.

### SUMMARY

Implementations of the present disclosure are generally directed to a system for distributing graphic content over a public network for inclusion in a linear television broadcast or in a live video stream distributed via a public data network. The system can include a graphics processing system that provides static and dynamically-generated graphics over a public network to a television production or television broadcast facility for inclusion in a linear television broadcast (such as a standard live or pre-recorded television program) or a live video stream distributed via a public or private data network. The graphics processing system can also collect, aggregate, and deliver real-time data from users for inclusion in the dynamically-generated graphics. For example, the graphics processing system can receive voting data from devices of users viewing a contest show indicating the user's preference between two contestants on the show. This graphics data can then be used to generate a results graph for inclusion in the television broadcast. The same or a similar graph can also be displayed on the user devices before or at the same time as the graph is displayed in the television broadcast. In this way, real-time (or substantially real-time) voting feedback can be displayed during a live television broadcast on one or both of the television feed (or a live video stream) or users' devices. Other types of data (e.g., comments) from users can also be received from user devices for inclusion in the television program or a live video stream distributed via a public or private data network. The graphics provided by the graphics processing system may also include transparency information (e.g., alpha channel or chroma key information) to allow the graphics and any embedded data to be overlaid onto the video feed for the television broadcast by a video switcher or other appropriate hardware. Because the graphics processing system can provide graphics over a public network such as the Internet, the television producer is not restricted to using a co-located graphics processing system in a television production or broadcast facility. The producer is also not restricted to using graphics that have previously been uploaded to a co-located graphics system, thereby offering the producer a flexible, timely, and dynamic solution for the inclusion of real-time graphics and related data in a live or pre-recorded linear television program delivered via traditional broadcast means or via a public or private data network as an Internet Protocol (IP) unicast or IP multicast stream. Moreover, the graphics can be provided in the form of a web page, such that the graphics can be retrieved using a specified uniform resource locator (URL) and the web page can be used as an input for overlaying onto the television video feed.

In general, innovative aspects of the subject matter described in this disclosure may be embodied in methods that include the actions of receiving a web page with imbedded graphics including transparency information (e.g., alpha channel or chroma key information) for presentation in a linear television broadcast from a remote web server via a public network, compositing the received graphics web page with video data to form a composite video image and transmitting the composite video image for distribution in a linear television broadcast or in a live video stream distributed via a public data network. The web page includes graphics data for inclusion in the linear television broadcast and data defining one or more transparent regions, and the compositing is performed by a video switcher. Other embodiments of this aspect include corresponding systems, apparatus, and computer programs, configured to perform the actions of the methods encoded on computer storage devices.

Additional innovative aspects of the subject matter described in this disclosure may be embodied in methods that include the actions of receiving user feedback from each of a plurality of users in response to information presented on a user device, aggregating the user feedback to generate aggregated data, generating graphics data based on the aggregated data (e.g., in real-time) and transmitting the graphics data over a public network to a television production or broadcast facility for compositing the graphics data imbedded in a web page with video from any of a variety of sources. Other embodiments of this aspect include corresponding systems, apparatus, and computer programs, configured to perform the actions of the methods, encoded on computer storage devices.

An additional innovative aspects of the subject matter described in this disclosure may be embodied in methods that include receiving (e.g., using a graphics server) a web page including graphics data from a web server via a network, wherein the graphics data includes data defining one or more transparent regions; receiving (e.g., on a video switcher having a plurality of input channels) the graphics data from the graphics server on a first input channel; receiving video data on a second input channel; generating (e.g., on the video switcher) a composite video image based on the video data and the graphics data using the data defining the one or more transparent regions of the graphics data; and transmitting the composite video image for inclusion in a linear television broadcast on a transmission channel. Other embodiments of this aspect include corresponding systems, apparatus, and computer programs, configured to perform the actions of the methods, encoded on computer storage devices.

These and other embodiments can each optionally include one or more of the following features. The web page includes formatting information specifying a position and orientation at which the graphics data should be included in the linear television broadcast. The formatting information is defined by a markup language code. The web page includes one or more dynamic elements operable to display updated information from the remote web server without the web page being refreshed. The received web page is rendered by a web browser prior to the compositing the received web page with video. The graphics data comprises a file identified in the web page. The file defines one of a single static image, streaming data, or one of a plurality of sequential files representing video. The graphics data includes an alpha channel defining the one or more transparent regions. The graphics data includes chroma key data defining the one or more transparent regions. The graphics data defines graphics formatted according to a first resolution of the linear television broadcast, and a second web page including graphics data defining graphics formatted according to a second resolution of a linear television broadcast is received. The graphics data includes video. The video data is delivered according to a frame rate of the linear television broadcast. The graphics data includes a static image. The data defining one or more transparent regions includes a plurality of levels of transparency. Receiving graphics data includes receiving, via the network from at least one remote web server, a plurality of graphics files, and compositing the received graphics data includes compositing the plurality of graphics files and the video from at least one other channel. A plurality of web pages are received via the network from at least one remote web server, wherein each web page includes graphics data for inclusion in the linear television broadcast and data defining one or more transparent regions, and the received web pages are composited, based on the one or more transparent regions, with each other and with video from at least one other channel using a video switcher to form the composite video image. The plurality of graphics files includes at least one static image and at least one dynamic data stream. Each of the plurality of graphics files includes data defining one or more transparent regions. At least a portion of the video is captured from the at least one other channel concurrently with receiving at least a portion of the graphics data via the network from the remote web server. A request for the graphics data is sent to the remote web server using a web address associated with the graphics data. The request for graphics data includes a uniform resource locator for the web page. The request for graphics data is sent by the video switcher using an application programming interface associated with the remote web server. The remote web server places the graphics data in an intermediary data table in response to the request. The methods further include receiving, at the remote web server via a public network, input from a plurality of user devices, and generating at least a portion of the graphics data based on the input received from the plurality of users. The methods further include generating additional graphics data defining graphics for presentation on user devices, wherein the additional graphics data is based on the input received from the plurality of users and includes content substantially similar to the graphics data included in the web page composited into the composite video image; identifying additional content for presentation on each of the plurality of user devices, wherein the additional content for each user device is identified based on metadata associated with the user device; and transmitting the additional graphics data and the identified additional content to each of the plurality of user devices for display on the user devices. The input from the plurality of user devices is received in response to information presented in the linear television broadcast. The input from each of the plurality of user devices is received in response to information received by the user device for presentation on the user device. The information received by the user device is received from a server system associated with the remote web server. The information received by the user device is defined through an administrator interface associated with the server system. The administrator interface includes one or more templates for formatting the input received from the plurality of users. The graphics data are provided to each of the plurality of users. The graphics data includes dynamic data generated based on feedback from viewers of the linear television broadcast. The graphics data is based at least in part on input received through an administrator interface associated with the remote web server. User feedback is provided through an interface on the user device. The graphics data generated based on the aggregated data includes data defining one or more transparent regions. The graphics data is transmitted over a network to at least one of a television production facility or a television broadcast facility for compositing the graphics data with video. The user feedback comprises a selection of one of a plurality of options presented on the user device. The user feedback comprises a rating. The information presented on the respective user devices is transmitted to each of the user devices. The graphics data is transmitted over a network to each of a plurality of television production facilities or television broadcast facilities for compositing the graphics data with video. The graphics data is transmitted in response to a request received from each of the plurality of television production facilities or television broadcast facilities. A plurality of different versions of the graphics data are generated, and one of the plurality of different versions of the graphics data is transmitted to a corresponding television production facility or television broadcast facility for compositing the graphics data with video. Each of the plurality of different versions of the graphics data is associated with a different uniform resource locator and the version transmitted to each television production facility or television broadcast facility is selected based on a uniform resource locator request received from the television production facility. A graphics server is adapted to request the web page including graphics data from the web server. The web server pushes the web page including graphics data to the graphics server. The graphics server is adapted to receive a plurality of sets of graphics data from the web server, wherein each set of graphics data includes data defining one or more transparent regions for the respective set of graphics data. The video switcher further includes a third input channel adapted to receive additional graphics data from the graphics server. The web server is adapted to generate the graphics data based on feedback received from viewers of the linear television broadcast.

Particular embodiments of the subject matter described in this specification can be implemented so as to realize one or more of the following advantages. The subject matter can be used to generate graphics for presentation in broadcast linear television programs at a location remote from a television production or broadcast facility and using conventional computing systems and software. Thus, remote producers can control the graphics seen by television viewers, including for use during live events such as live performances or sporting competitions such that producers physically attending such events can drive participation from a television audience while the actions are played out within a live venue. Such graphics can be formatted such that they can be incorporated directly into television programming without a need to modify or reformat the graphics and such that they can be composited with other graphics and/or video received or generated at the production or broadcast facility. Graphics do not need to be manually generated on-site using conventional broadcast graphics generation systems. This capability avoids conventional broadcast workflows, in which a technical director directs an on-site graphics system operator(s) to queue the graphics and then separately combine the data feed to the graphics fed by the local operator. The techniques described in this specification allows a producer and director to conduct graphics generation and modification activity either on-site or remotely more dynamically and with less manual intervention by the on-site graphics system operator(s). Among other things, technical directors and producers can respond to events as they unfold in the program, particularly during live programming. For example, if a random or spontaneous event takes place within a live music show, a conventional broadcast workflow would require that a broadcast graphics operator had already created a verbal audience call to action and graphics to accompany a particular event. Otherwise, by the time an operator creates such graphics, the opportunity for the producer to take advantage of the spontaneous event by soliciting audience participation will have passed. Transparency information (e.g., alpha channel or chroma-key green information) can be included with, or as a part of, the graphics data to facilitate compositing. The graphics data can be delivered as imbedded graphics data within a web page. Graphics can be generated for use in multiple broadcasts (e.g., originating from different local stations and broadcast at the same or different times), while concurrently providing customized features for each broadcast instance. For example, two local television stations can broadcast the same sporting event but can customize the on-air graphics and viewer participation data such that the respective viewers in each station's market see the brand and/or advertising of the respective local television station displayed on the television screen. The customized graphics and data can be made available as a result of each station directing a browser to retrieve web pages from different URLs set up for each station or broadcast facility. The graphics can be generated dynamically and can be based on substantially real-time feedback or input received from viewers of the television program and/or other users. Static and/or dynamic graphics can be displayed contemporaneously on the same user devices implemented to submit a response (and/or on other devices); providing users/viewers with a sense of immediate participatory feedback. Contemporaneous delivery to the user devices can be real-time throughout the duration of the interactive event, while the television producer may show the results within the linear program at a later and/or for a shorter period of time than the duration of the interactive event. Push graphics (questions and data) from a mobile device to TV viewers and to spectators in live venue, e.g., at sporting events.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a functional block diagram of an example system for distributing content over a public network for inclusion in a linear television broadcast.

FIG. 1B is a functional block diagram of an alternative configuration of an example system for distributing content over a public network for inclusion in a linear television broadcast.

FIG. 2 is an example of a graphic element including chroma key transparency information.

FIG. 3 is an example of a graphic element with associated alpha channel transparency information.

FIG. 4 is an illustration of a compositing process involving two graphics encoded with chroma key transparency information.

FIG. 5 is an illustration of a compositing process involving two graphics with associated alpha channel transparency information.

FIG. 6 is a functional block diagram illustrating the compositing of chroma key encoded graphic data from the Internet with live video data.

FIG. 7 is a functional block diagram illustrating the compositing of alpha channel encoded graphic data from the Internet with live video data.

FIG. 8 is an illustration of an administration interface for controlling a live voting application.

FIG. 9A is an illustration of a user interface for a live voting application.

FIG. 9B is an illustration of a user interface for a live voting application showing voting results.

FIG. 10 is an illustration a live voting system including a live voting application and associated voting results shown on a linear television broadcast.

FIG. 11 is a flowchart illustrating a method for distributing content over a public network for inclusion in a linear television broadcast.

FIG. 12 is a flowchart illustrating a method for receiving and presenting user feedback associated with a linear television broadcast.

FIG. 13 is a diagram illustrating an example interaction between a video switching system and a graphics processing system.

Like reference numbers and designations in the various drawings indicate like elements.

### DETAILED DESCRIPTION

Implementations of the present disclosure are directed to systems and methods for distributing content over a public network for inclusion in a linear television broadcast. The linear television broadcast can be broadcast via traditional television distribution infrastructure or via public or private data networks. A graphics processing system connected to a public network (e.g., the Internet) stores a plurality of graphical elements for inclusion in linear television broadcasts that can be delivered in a web page. The graphics data includes transparency information (e.g., an alpha channel or chroma-key coloring) for use in compositing the graphics with other data sources such as additional graphics or video data. This compositing can be performed by the graphics processing system, the video switching system (discussed below), or by any combination of these or other components. In addition, the graphics can include static images (e.g., static logos) or may be dynamically generated by the graphics processing system. The dynamic images can be generated based on and can include data provided by an operator or producer, such as headlines or statistics for a live sporting event. The dynamic images can also be generated based on data from external users, such as real-time voting data in response to a competition program. In such an implementation, the external users can use an application on a device such as a laptop, smartphone or tablet to provide the real-time voting data.

In some implementations, the graphics processing system provides a formatted web page including graphics for inclusion in a linear television broadcast formatted as they should appear on the television screen in the final broadcast. This formatted web page can be accessed from a uniform resource locator (URL) and can include transparency information for use in compositing the graphics with video and/or other graphics. The transparency information can be in the form of alpha channel or chroma key information included on the web page. Further, the formatted web page may include dynamic elements that may be updated when new data is available without the need to refresh the entire web page. In some cases, the web page including the graphics information may be accessed by a broadcast or production facility user on a workstation using a web browser program. The web browser program may render the web page received from the graphics processing system, and the output signal from the web browser program may be fed to a broadcast graphics system or video switcher for inclusion in a linear television broadcast. In some cases, the retrieval of the web page may be performed automatically (such as according to a schedule) without the need for a user to interact with the web browser program.

In some implementations, the graphics processing system provides the static and/or dynamically-generated graphics via a public network to a video switching system for inclusion in a linear television broadcast and also for inclusion in content sent back to user devices, e.g., that provide input for the dynamically-generated graphics. The video switching system can include a broadcast graphics server, a video switcher, a combination of the two, or other equipment. The video switching system composites the graphics provided by the graphics processing system with a live or recorded video feed. This composite video feed including the graphics is then passed to a video distribution system for broadcast via traditional television distribution infrastructure or via public or private data networks.

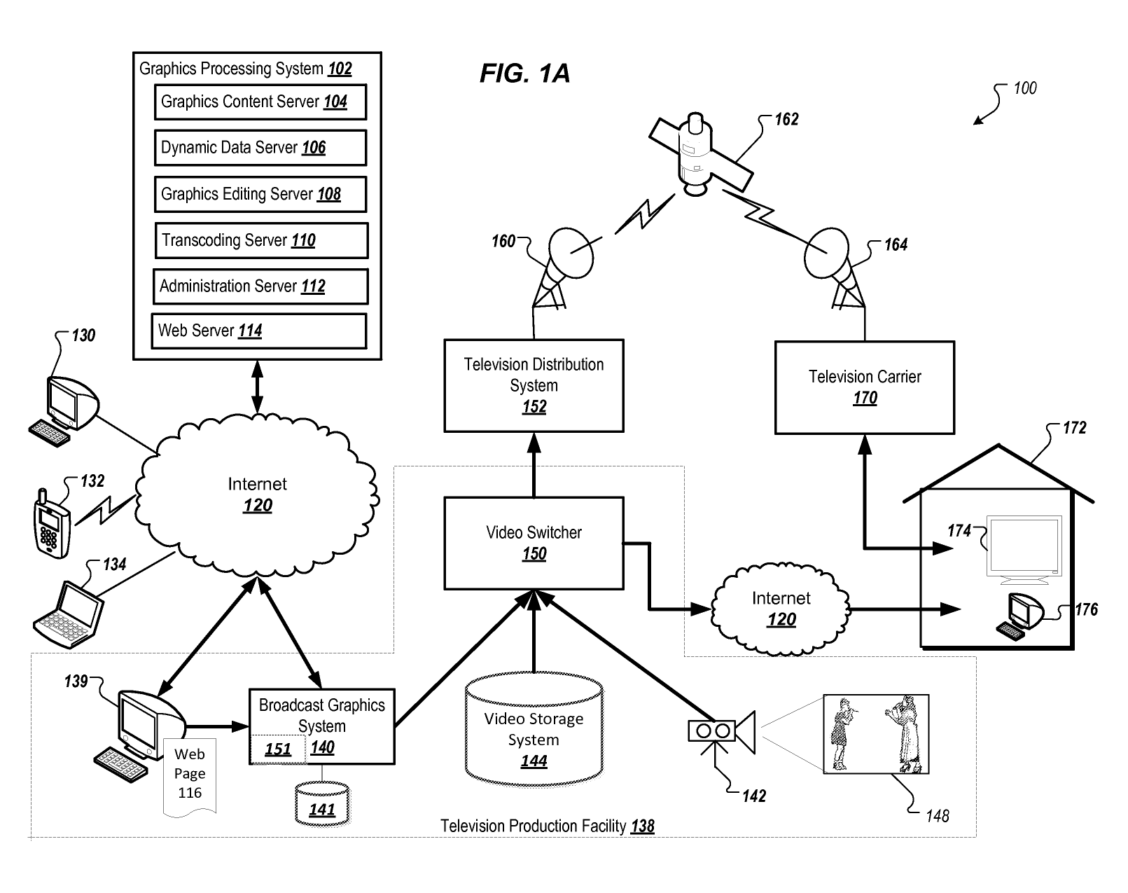

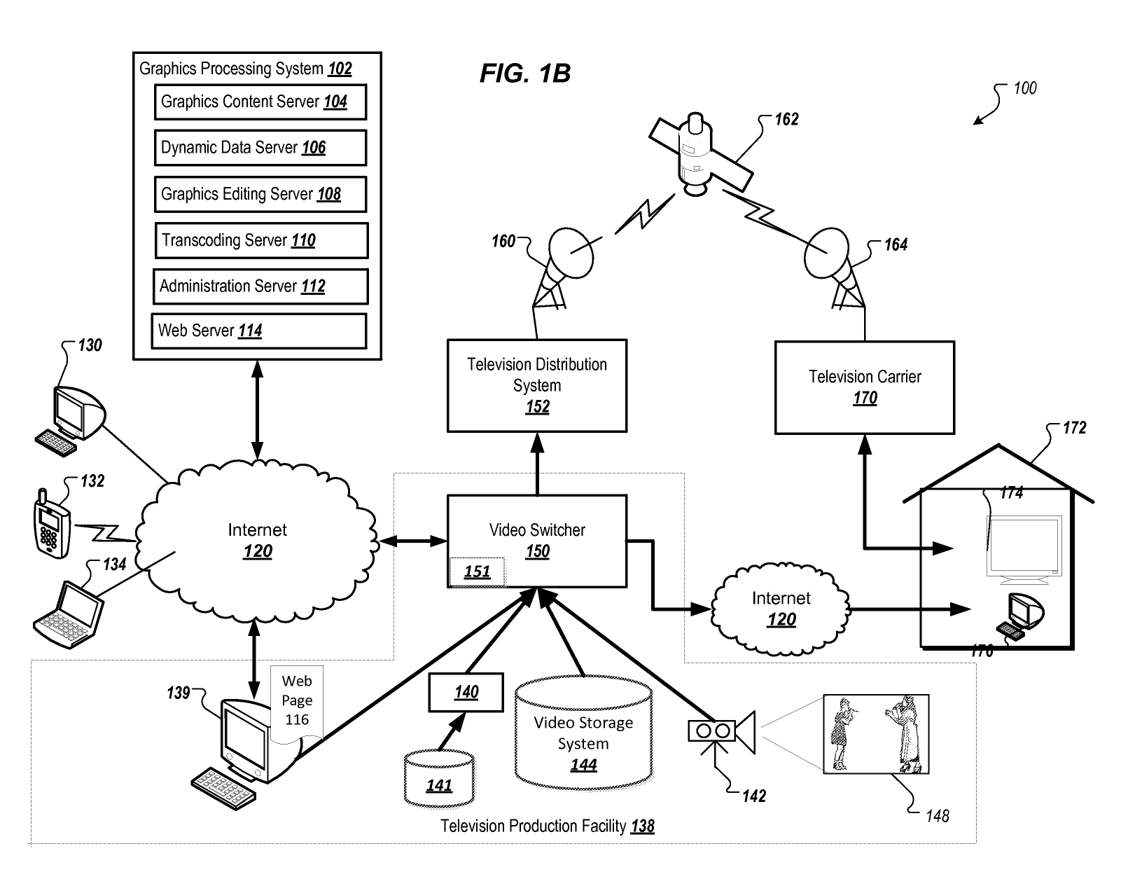

FIG. 1A depicts an example system 100 for distributing content over a public network for inclusion in a linear television broadcast. The system 100 can be provided as a set of interconnected software and server systems, databases, video capture devices, and other components. These components can be used to provide graphics data embedded in a web page over a public network to equipment in a television production or broadcast facility 138 for inclusion in a linear television broadcast. The web page can include data representing pixel information for presentation on a screen. This pixel information can include color and opacity information to configure each pixel of an output screen in order to display the graphics data. The graphics data can be stored in various formats on the graphics processing system 102 (e.g., JPEG, GIF, TIFF, etc.) and then converted or transcoded into a format or layout required by the television production facility 138. For example, the graphics processing system 102 can provide graphics data for inclusion in a linear television broadcast to the television production or broadcast facility via a URL that identifies a web page in a format, a resolution, and an aspect ratio identical to that of the linear television broadcast. In this way, the television production or broadcast facility 138 does not have to perform a conversion on the graphics data before compositing it with a video feed. Although the depicted implementation shows a one to one relationship between the graphics processing system 102 and the television production or broadcast facility 138, in other implementations the graphics processing system 102 can provide graphics data to a plurality of different television production or broadcast facilities. Further, in some implementations, multiple graphics processing systems can provide graphics data to the same television production or broadcast facility.

In some cases, the graphics processing system 102 can provide graphics data in several different formats, resolutions, and aspect ratios according to the requirements of the specific linear television broadcast in which the graphics data is to be included. Each version (of what) can be provided on a corresponding web page with a unique URL. For example, the television broadcast facility 138 may produce and distribute for broadcast a high definition and standard definition version of the same program. The graphics processing system can provide graphics data to accommodate a resolution of 1080i, and an aspect ratio of 16:9 for the high definition version of the program on one web page, and can provide the graphics data to accommodate a resolution of 480i, and an aspect ratio of 4:3 for the standard definition version of the program on another web page. If a single broadcast facility 138 simulcasts both HD and SD television feeds, then the facility will simultaneously use two separate web pages for compositing graphics into the separate HD and SD television feeds.

In some implementations (e.g., if the graphics data includes video), the graphics processing system 102 provides the graphics data according to a frame rate associated with the linear television broadcast. For example, for US broadcasts, the graphics processing system 102 can provide the graphics data as a video stream with a frame rate of 29.97 frames per second. In some cases, this frame rate is an attribute of the video stream or the encoded video file provided by the graphics processing system 102 (e.g., in a web page), while in implementations that involve providing multiple graphics files, the frame rate may correspond to the rate at which distinct images (e.g., in new or updated web pages) are provided by the graphics processing system 102.

In some cases, the graphics data provided by the graphics processing system 102 includes a file representing a single static image. The file may also represent streaming data. For example, the graphics data may be a file formatted according to a streamable video format. The graphics data may also include a plurality of sequential files representing video. For example, the graphics processing system 102 may provide a series of video segments including the graphics data. The individual segments may correspond in length to the amount of time the graphics should remain on screen. Such an approach may simplify synchronization and scheduling of the graphics at the television production or broadcast facility 138.

In the illustrated implementation, a graphic processing system 102 provides graphics data embedded in a web page associated with a particular URL to a broadcast graphics system 140 over a public network, such as Internet 120, or over a private network, such as with deployments to broadcast station groups that use a “hub and spoke” distribution technique on private data networks. The graphics data may include static content and/or dynamic content generated based on data from an external source. For example, the external data may include data from applications running on user devices connected to Internet 120, such as desktop 130, smartphone 132, and/or laptop 134 (or other suitable devices, such as tablet computers) or through online communities. These devices may provide data to the graphics processing system 102 over the Internet 120 for inclusion in the dynamically-generated graphics content. The graphics data provided to the broadcast graphics system 140 can then be fed to a video switcher 150 to be composited with one or more video feeds, such as a live feed from camera 142 or a recorded feed from video storage system 144. The video switcher 150 may use transparency information encoded in or included with the graphics data in performing the compositing. The video switcher 150 then feeds the composite video signal to a television distribution system 152 for broadcast. The television distribution system 152 utilizes communications array 160 to communicate the video feed to a communications array 164 associated with a television carrier 170 via satellite 162. The television carrier 170 may then provide the video feed to household 172 for viewing on television 174. The video switcher 150 may alternatively distribute linear programming via an over the top streaming solution using a public data network such as Internet 120.

In some implementations, the system 100 includes a graphics processing system 102. The graphics processing system 102 may include various components to enable the storage, processing, and transferring of dynamic and static images included in a web page for inclusion in a linear television broadcast. In some implementations, the graphics processing system may be a single component (such as a server) or may be collection of distributed components performing the required functions cooperatively. The graphics processing system 102 may also include various storage components (e.g., databases) for holding graphics files, templates, configuration information, and other information necessary for providing the graphics files in a web page via the Internet 120.

In the illustrated implementation, the graphics processing system 102 includes a graphics content server 104. In some instances, the graphics content server 104 is operable to control the transfer of graphics files from the graphics processing system 102 to an external destination, such as the broadcast graphics system 140 (or directly to the video switcher 150), over the Internet 120. These transfers may be performed by any appropriate mechanism associated with delivering web pages over the Internet 120 or a private network, including, but not limited to, utilizing transmission control protocol (TCP), universal datagram protocol (UDP), hypertext transfer protocol (HTTP), or any other appropriate protocol or combination of protocols.

The graphics content server 104 may also be operable to organize, catalog and store the graphics assets associated with the graphics processing system 102. In some instances, the graphics content server 104 controls the operation of the various other components of the graphics processing system 102 (discussed below). The graphics content server 104 and graphics processing system 102 can also be used to control aspects within the television production or broadcast facility 138. This control may be performed, for example, by controlling the contents of a database located in the television production or broadcast facility 138 (such as database 141).

The illustrated graphics processing system 102 also includes a dynamic data server 106. In some cases, the dynamic data server 106 is a software application or a dedicated server component operable to process data received from one or more external sources and produce dynamic graphics data indicative of the received data. The dynamic data server 106 may also be operable to perform statistical calculations based on the received data to produce charts or graphs generated based on the received data. The charts or graphs can also include features or components defined by data stored by the graphics processing system 102 (e.g., data previously received from end users, or previously generated for inclusion), created by an administrative user of the graphics processing system 102, or received from another source. For example, the dynamic data server 106 may produce a graph showing the voting results for a live television program in the form of a line graph showing the percentage of favorable votes over time. In some instances, the dynamic data server 106 may include a record of previously received data for use in creating such historical graphics.

The dynamic data server 106 may also be operable to generate specific data based on the intended use of the graphics data. For example, the dynamic data server 106 may be operable to produce graphic content branded specifically for the television production or broadcast facility 138 or the television distribution system 152. This may include inserting specific logos or other identifying information associated with these systems, certain advertising sponsors, or other branding opportunities. In other cases, the dynamic data server 106 may generate graphics data specific to a geographic region or location where the graphics data will eventually be broadcast. Different geographic regions may simultaneously receive independent graphics depending upon the URL for the respective data, thereby creating a custom viewing experience for each region. For example, the dynamic data server 106 may access third party web servers via Internet 120 to retrieve digital advertising sponsorships for a particular geographic region.

The depicted graphics processing system 102 also includes a graphics editing server 108 operable to allow a user to create new graphics data or edit existing graphics. A user of the graphics processing system 102 can use the graphics editing server 108 to generate a graphic or multiple graphics for addition to the overlay websites for further inclusion in a linear television broadcast. In some cases, a user of the graphics processing system 102 may use the graphics editing server 102 to enter information into a pre-generated template. For example, a template may include various fields into which the user can enter data. The data may be related to the linear television broadcast into which the graphics data will eventually be inserted. For example, a user could enter sports statistics into a template to be included in a broadcast of a sporting event.

In some cases, the graphics editing server 108 allows the user to combine multiple existing or newly-created graphics into a single web page graphic overlay. This action may be performed by compositing the various graphics using transparency information (e.g., chroma key color information or alpha channel information) associated with the graphics. Alternatively, multiple images can be provided to an external system in parallel for use by the external system, which can perform any desired compositing. For example, a stock ticker graphic can be provided in a separate web page file or feed from a web page file that defines a logo. A particular production or broadcast facility can selectively combine the images from the different web page files and/or feeds, or can select from multiple available web page feeds or images. In this manner, the production or broadcast facility can conveniently customize its broadcast graphics. Moreover, a web page with a combined image can be provided by the graphics processing system 102 for selective retrieval by production or broadcast facilities as an alternative option to retrieving the separate components of the image in different web pages. Accordingly, each production or broadcast facility can choose to control customization of the broadcast by separately retrieving individual graphics components or to simplify production or broadcast by retrieving images and/or video that are combined at the graphics processing system 102. In some instances, the graphics editing server 108 may also be operable to change the resolution (e.g., standard definition, high definition (HD)), aspect ratio (e.g., 4:3, 16:9), or other attributes of a graphic or video feed to match the specifications of a destination system (i.e., the television distribution system).

The illustrated graphics processing system 102 also includes a transcoding server 110 operable to transcode or convert certain graphics data to be provided by the graphics processing system 102 into an appropriate format for the system to which the graphics data is being provided. For example, the transcoding server 110 may be operable to encode original video graphics data and/or the transcoded data in an appropriate container format such as Material Exchange Format (MXF).

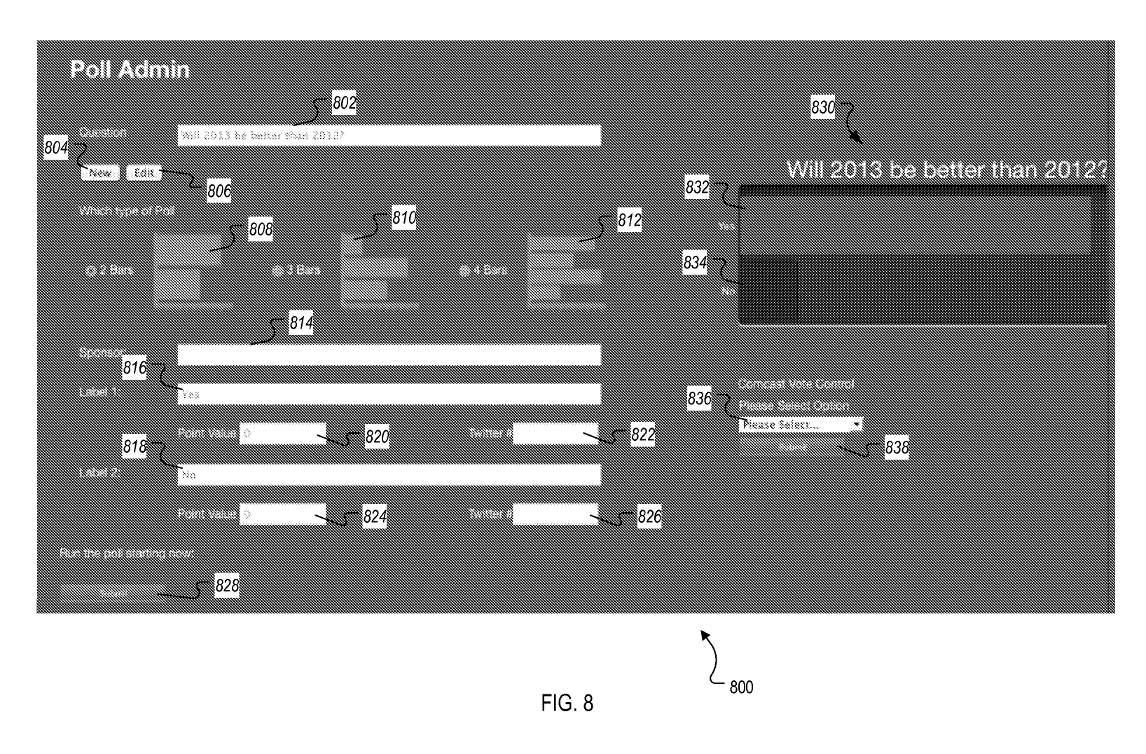

In the illustrated implementation, the graphics processing system 102 also includes an administration server 112 operable to allow an administrator to configure various aspects of the system, including an ability to control timing and content of delivery of and/or inclusion of graphics data in a linear television broadcast. For example, an administrator could selectively insert graphics into a live television program using the administration server 112. In one case, the administration server 112 may allow the administrator to specify a poll question for presentation on the user devices 130, 132, and 134. In another example, the administration server 112 may allow for the customization and configuration of the dynamic graphics created by the dynamic data server 106, including the ability to supply data for inclusion in those graphics. In general, the administration server 112 may also allow for the customization and configuration of the graphics included in web pages associated with different URLs. The administration server 112 may also include a web server for presenting a web page of options (or as a thin client or installed application on a tablet computer or other mobile device) to the administrator (as shown and discussed further in FIG. 8). In some cases, the administration server 112 allows for control of items with the television production or broadcast facility 138. For example, the administration server 112 may update values in the database 141 of the television production or broadcast facility 138 to control various aspects of the presentation of graphics in a linear television broadcast.

The graphics processing system 102 also includes a web server 114. In some cases, the web server 114 may be operable to interact with components inside the television product facility 138 through the Internet 120 and provide the components with graphics information for inclusion in a linear television broadcast. The web server 114 may provide the graphics information in the form of a web page 116. The web page 116 may include formatting and layout information such that when the web page is loaded in a web browser, the page that is displayed will show the graphics in the location and orientation that they should be displayed in the linear television broadcast. For example, in one implementation, an operator may use a graphics retrieval system (such as graphics retrieval system 139, discussed below) to retrieve a web page 116 associated with a URL from the web server 114. A web browser 151 running on the graphics retrieval system 139 may render the web page according to the contents of the page. The rendered page may then be output to the broadcast graphics system 140, the video switcher 150, or another component for additional processing, compositing, or other modification prior to broadcast. In some cases, the web pages provided by the web server 114 may include layout and formatting information, including Hypertext Markup Language (HTML) tags, cascading style sheet (CSS) information, HTML5 directives, or any other appropriate layout information. The web page 116 may also include Asynchronous JavaScript and XML (AJAX) elements that are updated on the page when new content is received without the entire page needing to be refreshed. The web page 116 may also include other mechanisms for displaying dynamic content such as FLASH objects, animated graphics, scripts, applets, or any other suitable mechanism for displaying content. The web page 116 may also contain chroma key or alpha channel transparency information related to the graphics.

In some implementations, the web server 114 utilizes Hypertext Transfer Protocol (HTTP) to transfer the web pages 116 and their embedded graphics data to components within the television production or broadcast facility 138. The web server 114 may also utilize any other networking protocol for this transfer, including, but not limited to File Transfer Protocol (FTP), Remote Procedure Call (RPC), HTTP Secure (HTTPS), or any other suitable protocol.

The dynamic data server 106 is communicatively coupled to Internet 120, which it may use to transfer information to and from the user devices 130, 132 and 134 and the broadcast graphics system 140 or video switcher 150. In some implementations, different content servers can be used for communicating with user devices 130, 132, and 134 and for communicating with broadcast graphics systems 140 or video switcher 150. In some cases, Internet 120 may be any suitable public network, a combination of public and private networks, cellular or other telecommunications network, or a local area network. Internet 120 may also include various virtual private networks or secure tunnels established between the graphics processing system 102 and the components with which it communicates for increased security.

One or more user devices may also be communicatively coupled to Internet 120 or an online community. In the illustrated implementation, the user devices include a desktop 130, a smartphone 132, and a laptop 134. The user devices 130, 132 and 134 may include software allowing the devices to interact with graphics processing system 102 to provide real-time reaction data from the users of the devices. In some cases, the reaction data may be provided in response to a linear television broadcast, such as, for example, a live broadcast featuring a competition requiring users to vote to determine a winner. In such cases, the real-time voting data generated by the user devices 130, 132 and 134 may be passed to the graphics processing system 102, where dynamic graphics content may be generated or updated based on the voting results. This dynamic content may then be provided to the television production or broadcast facility 138 for inclusion in the live broadcast. The dynamic content may also be provided to the same or different user devices 130, 132 and 134 that submit the voting data. In some implementations, graphics including results data can be provided from the dynamic data server 106 to user devices from which votes are submitted (and/or to other user devices), and the graphics can further include content (e.g., advertising selected from an advertising inventory) selected for each user device according to metadata associated with the respective user device (e.g., metadata identifying a location of the user device, user profile information, and the like).

In some cases, the user devices can provide the real-time voting data to the graphics processing system 102 by having the user interact with a web page retrieved from the graphics processing system 102. In such cases, the web page can include an embedded voting application allowing users to input votes. Alternatively, the real-time voting data can be submitted through a frame (e.g., an iFrame) embedded in or linked through a third-party online community (e.g., Facebook® pages). In one implementation, the web page including the embedded voting application is implemented using Asynchronous JavaScript and XML (AJAX) techniques, thus allowing the web page to send and receive information from the graphics processing system 102 without interfering with the display on the page. Such an implementation can update displayed graphics (such as results graphs) on the page without reloading the entire page. Alternatively, users can interact with an application installed on the user devices that can receive presentation data from the system 102. Either way, in some implementations, the data displayed on the user device to receive feedback or input can be controlled in part from the system 102 (e.g., according to selections or programming provided by an administrator through the administration server). In addition or as an alternative, users can submit votes through other communication techniques (e.g., text messages, Twitter hashtags, toll-free telephone numbers, etc.).

In the illustrated example, television production or broadcast facility 138 is also communicatively coupled to Internet 120 or a private data network. In some cases, television production or broadcast facility 138 may be a single location including all the depicted equipment, while in other cases the depicted equipment may spread across multiple locations. The television production or broadcast facility may include a broadcast graphics system 140. The broadcast graphics system 140 may be a system utilized by an operator to control the inclusion of graphics data in a linear television broadcast. The broadcast graphics system 140 may also receive the graphics data from graphics processing system 102 via Internet 120 for inclusion in a linear television broadcast. The broadcast graphics system 140 may include conventional broadcast graphics generation functionality for generating, storing, and delivering graphics for inclusion in a linear television broadcast. In accordance with the techniques described in this specification, however, graphics can be delivered as a web page from a remote web server and rendered using a web browser 151 instead of (or in addition to) generating graphics using the conventional broadcast graphics generation functionality.

In some implementations, the broadcast graphics system 140 or the video switcher 150 may be operable to request the graphics data from the graphics processing system 102. The broadcast graphics system 140 or the video switcher 150 can send a request identifying a specific uniform resource locator (URL) associated with desired graphics data from the graphics processing system 102. In some cases, the URL may be associated with a web page 116 specifying the exact layout in which the graphics data should appear in a linear television broadcast. For example, the web page can include hypertext markup language (HTML) code that specifies precise resolution and dimensions and a precise (not merely relative) position of graphics within viewable area of the linear television broadcast. In addition, the web page 116 can include an alpha channel or a chroma-key green background to indicate an area of transparency, and one or more images placed in different areas of the page to indicate their placement on a television screen. The URL may also be associated with a web page 116 including various dynamic elements that are updated or pushed based on instructions from the server. For example, the web page 116 may include Asynchronous JavaScript and XML (AJAX) elements that are updated on the page when new content is received without the entire page needing to be refreshed. The web page 116 may also include other mechanisms for displaying dynamic content such as FLASH objects, animated graphics, scripts, applets, or any other suitable mechanism for displaying content. In some cases, the web page may also include layout information such as HTML formatting tags, cascading style sheets (CSS), HTML5 directives, or other suitable layout information. The resulting image generated when the web page 116 is rendered by a browser 151 (running on the broadcast graphics system 140 or the video switcher 150 or a separate graphics retrieval system 139 further described below) can be provided as an input to the video switcher.

In some cases, the URL may be specific to the broadcast graphics server 140, the video switcher 150, or the television production or broadcast facility 138, allowing the graphics processing system 102 to respond with custom graphic specifically designed or generated for the requesting component or facility. The URL may also correspond to a region, location, or target network for the requested graphics data, allowing the graphics processing system 102 to provide data customized according to one or more geographic, demographic, network, affiliate, or other parameters. For example, if the graphics data is to be composited with a video feed for a specific local network, the URL may indicate that network, allowing the graphics processing system 102 to respond with a customized graphic including the logo of the network.

In some cases, the broadcast graphics system 140 or the video switcher 150 may also be operable to poll the graphics processing system 102 for updates to the graphics data. In some implementations, the graphics processing system 102 may update a database (such as graphics management database 141 or another database specific to graphics processing system 102) when the graphics data changes and the broadcast graphics system 140 or the video switcher 150 may query the database when it requires a new version of the graphics data. In some cases, such a database may include insert or update triggers to automatically send the graphics data to the broadcast graphics system 140 or the video switcher 150 when it is inserted or updated by the graphics processing system 102, thereby allowing the graphics displayed in a television broadcast to be controlled through the graphics processing system 102 (including from a device that remotely accesses, e.g., the administration server 112 or the graphics content server 104). The broadcast graphics system 140 or the video switcher 150 may also receive, request, or retrieve a stream of video data from the graphics processing system 102 including the graphics data. In some cases, the broadcast graphics system 140 or the video switcher 150 may include a software application associated with the graphics processing system 102 to perform the retrieval and processing of the graphics data. In some implementations, the broadcast graphics system 140 or the video switcher 150 can use an application programming interface (API) (e.g., a specially programmed browser) associated with the graphics processing system 102 to access the graphics data included in a web page. The broadcast graphics system 140 or the video switcher 150 may also include one or more servers or other components to perform the retrieval of the graphics data from the graphics processing system 102. As noted, the described functionality of requesting, retrieving, and receiving video, images, or other graphics may be integrated directly into the broadcast graphics system 140 or the video switcher 150 or implemented in a server or other computing device that interfaces with the broadcast graphics system 140 or the video switcher 150.

The television production or broadcast facility 138 may also contain a graphics retrieval system 139 associated with the broadcast graphics system 140 or the video switcher 150. In some cases, the graphics retrieval system 139 is a separate component from the broadcast graphics system 140 or the video switcher 150 and provides the broadcast graphics system 140 or the video switcher 150 with an output representing the graphics data retrieved from the graphics processing system 102. The graphics retrieval system 139 may also be integrated into the broadcast graphics system 140 or the video switcher 150 and may be provided instead of, in addition to, or as part of the graphical user interface (GUI) discussed below.

In some implementations, the graphics retrieval system 139 is operable to communicate with the web server 114 of the graphics processing system 102 over the Internet 120. The graphics retrieval system 139 can be (or can otherwise include) a browser program 151 executing as software (e.g., on a separate computer, on the broadcast graphics system 140, or on the video switcher 150) and this communication can involve a browser program requesting a web page 116 from web server 114. The communication may also involve the web server 114 providing data to the graphics retrieval system 139 without the data being requested (e.g., “pushing” the data). In one implementation, the graphics retrieval system 139 allows an operator to enter a URL of a web page 116 (hosted by webserver 114) corresponding to graphics to be displayed in a linear television broadcast. The browser then retrieves and displays the web page 116 to the operator. The operator can then select the web page 116 for output to the broadcast graphics system 140 or the video switcher 150 for inclusion in a linear television broadcast. In some cases, the browser program on the graphics retrieval system 139 is a standard web browser program including, but not limited, MICROSOFT® INTERNET EXPLORER, MOZILLA FIREFOX, GOOGLE CHROME, OPERA, or any other suitable web browser. The browser program may also be a custom software program specific to the application or needs of the television production or broadcast facility or the graphics processing system 102. For example, the browser program may have relatively limited functionality that operates to retrieve a web page 116 from a specified URL, render the web page 116 as necessary (e.g., according to HTML code included in the web page), and output the rendered image (or sequence of images) for input to a video switcher.

In some cases, the graphics retrieval system 139 may be operable to retrieve the web page 116 from the web server 114 without be instructed by a user. For example, the graphics retrieval system 139 may be programmed to retrieve and render the web page 116 from the web server 114 according to a schedule. The schedule may instruct the graphics retrieval system 139 to retrieve the web page 116 at a regular interval (e.g., every five minutes) or at specific times. As noted above, the web page 116 may also include dynamic aspects that cause the web page 116 to update without further retrieval triggers from the graphics retrieval system 139. The schedule may also be used to define different URLs for retrieving different web pages 116 at different starting times.

In some implementations, the graphics retrieval system 139 may output the rendered web page to the broadcast graphics system 140 or the video switcher 150 for inclusion in a linear television broadcast. In some cases, this output may be performed using any suitable visual output technology including, but not limited to, High-Definition Multimedia Interface (HDMI), Component Video, Ethernet, Universal Serial Bus, FireWire (IEEE 1394), or any other suitable technology.

In some implementations, the broadcast graphics system 140 or the video switcher 150 includes a graphical user interface (GUI) that is used to send a request for graphics data to the graphics processing system 102. For example, the GUI may include a browser allowing an operator to select and request different graphics data from the graphics processing system 102. The browser may retrieve a list of all or some of the available graphics data from the graphics processing system 102. In some cases, the browser is a web browser and the graphics processing system 102 provides the list to the broadcast graphics system 140 or the video switcher 150 formatted as a web page. In some implementations, the GUI may include the standard operating interface of the graphics broadcast system 140 or the video switcher 150. In such cases, an operator can use the GUI to perform operational tasks such as scheduling the appearance of graphics in the broadcast, entering data into graphics, and other tasks. In some implementations, the operator may select graphics available from the graphics processing system 102 for inclusion in the broadcast through the GUI. The broadcast graphics system 140 can then request, retrieve, or otherwise access the graphics data from the graphics processing system 102, and provide the graphics data to the video switcher 150 for inclusion in the linear television broadcast.

The broadcast graphics system 140 may also include or be communicatively coupled to a graphics management database 141. In some cases, this database is in a format associated with the broadcast graphics system 140, while in other cases it is a standard general purpose SQL database. The graphics management database 141 may be operable to store graphics data associated with the broadcast graphics system. In some cases, the graphics processing system 102 may update this graphics management database 141 via Internet 120 to provide graphics data to the broadcast graphics system 140. In some cases, the graphics processing system 102 may update the graphics management database 141 with graphics data in response to a request by the broadcast graphics system 140. The graphics management database 141 can also include data defining triggers that cause the broadcast graphics system 140 or another device in the television production or broadcast facility 138 to request updated graphics or graphics from a new or different URL for presentation within linear television programming. The graphics management database 141 can also include scheduling information specifying when graphics should appear in the linear television broadcast. In some cases, the graphics processing system 102 can update these schedules to effect the inclusion of graphics data into the linear television broadcast.

Also included in the illustrated television production or broadcast facility 138 are video storage system 144 and camera 142. The video storage system 144 can store previously recorded video footage to be mixed with the graphics from graphics processing system 102. The camera 142 may be operable to acquire live video images, such as images of scene 148. In some cases, the camera 142 captures video concurrently with the broadcast graphics system 140 receiving graphics data from the graphics processing system 102. The video storage system 144 and the camera 142 can provide their respective video feeds to video switcher 150 for compositing with graphics data from the graphics process system 102. Each input to the video switcher 150 is a separate channel, and the video switcher 150 is operable to mix or composite the different input channels together into a composite output. The video switcher 150 may perform this compositing by utilizing transparency information encoded in or provided with the graphics data from graphics processing system 102. The transparency information can be used to overlay the graphics data over the live or recorded video feed prior to broadcast. In some cases, the video switcher 150 can receive two or more graphics data elements as input channels and composite the graphics data elements with one or more video signals to produce the composite signal.

In some implementations, the output video signal produced by the video switcher 150 is formatted for transmission according to linear television broadcast standards, and thus does not require additional modification of the pixels or the frames of the signal prior to being broadcast to subscribers. In some cases, the output video signal produced by the video switcher 150 is formatted according to broadcast television engineering transmission standards. The output video signal produced by the video switcher 150 may also be formatted for “over-the-top” streaming (e.g., simultaneous or otherwise) to a user device 176 over the Internet 120. Further, the aspect ratio and resolution of the output video signal produced by the video switcher 150 can be such that no conversion of the signal is necessary prior to broadcast. For example, when outputting a signal for a high-definition (HD) broadcast, the video switcher 150 may produce an output video signal with 1080 interlaced (1080i) resolution and an aspect ratio of 16:9. When outputting a signal for a standard definition broadcast, the video switcher may produce an output video signal with 480i resolution and a 4:3 aspect ratio.

Although the video switcher 150 and the broadcast graphics system 140 are depicted as separate components in FIG. 1, in some implementations the components of the broadcast graphics system 140 are included in the video switcher 150. In such implementations, the video switcher 150 would interact with the graphics processing system 102 to retrieve, request, or otherwise access the graphics data via the Internet 120, as described previously relative to broadcast graphics system 140.

In the illustrated implementation, the video switcher 150 provides the composite video signal including the graphics data to television distribution system 152 for broadcast. The television distribution system 152 may include various hardware and software components, as previously described in co-pending U.S. patent application Ser. No. 13/185,471, entitled “CONTENT CREATION AND DISTRIBUTION SYSTEM,” which is hereby incorporated by reference. Television distribution system 152 may communicate the video information to television carrier 170 utilizing communication arrays 160 and 164 and satellite 162 (or alternatively using terrestrial broadcast distribution systems). Television carrier 170 may provide the video information to household 172 for viewing on television 174. As previously discussed, a simultaneous “over-the-top” stream of the may also be sent from the video switcher 150 through the Internet 120 to the user device 176 in household 172, which may be the same household or a different household than receives the linear television broadcast. In some cases, this stream may be sent by the television distribution system 152 instead of the video switcher 150.

FIG. 1B is a functional block diagram of another configuration of the example system 100 for distributing content over a public network for inclusion in a linear television broadcast. The example system 100 in FIG. 1B does not necessarily (or even include) use a broadcast graphics system 140. Instead, graphics data can be delivered directly to the video switcher 150, the graphics retrieval system 139, or other components of the television production or broadcast facility 138. In some cases, the functionality of the graphics retrieval system 139 may also be included within the video switcher 150, such that the graphics, web pages 116, or other information to be used in the linear television broadcast is requested, retrieved, or received from the graphics processing system 102 by the video switcher 150 over the Internet 120. For example, a web browser 151 executing on the video switcher 150 can retrieve a web page 116 from web server 114 and provide the rendered web page image as an input to one of multiple ports of the video switcher 150 such that the video switcher 150 composites the rendered web page image with images and/or video from one or more of the broadcast graphics system 140, the graphics management database 141, the camera 142, or the video storage system 144.

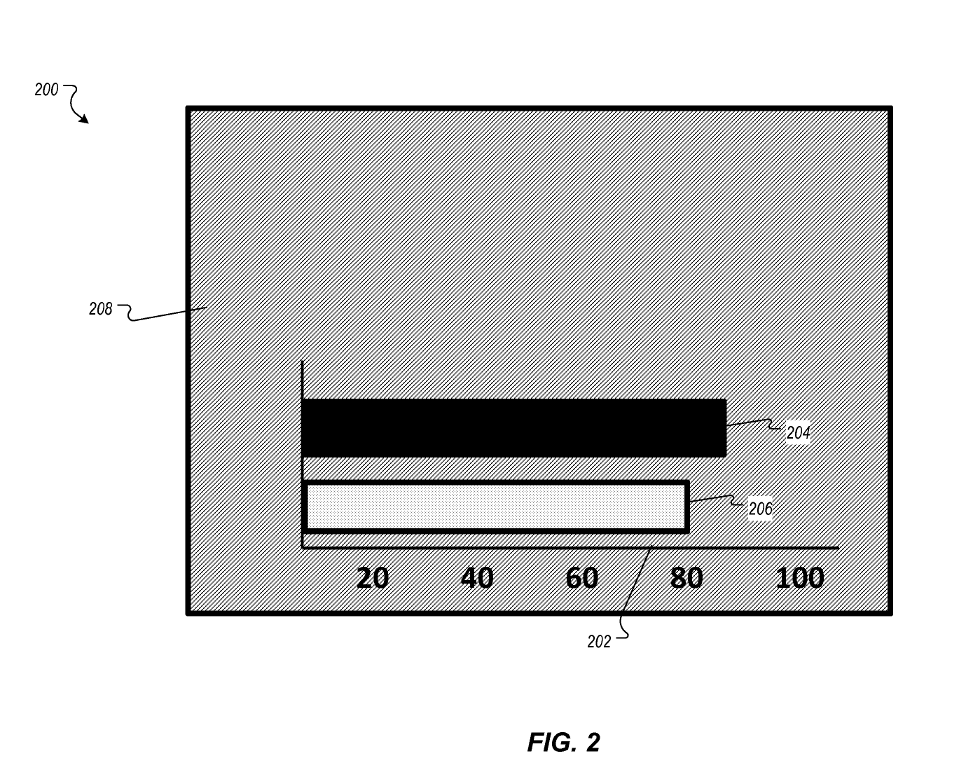

FIG. 2 shows an example graphic element 200 including chroma key transparency information. The depicted graphic element can be a web page that shows a graph representing two distinct values plotted against an axis 202. Bar 204 represents the first value and bar 206 represents the second value. The graphic element 200 is an example of a graphic element that may be produced to provide visualization for the real-time data discussed relative to FIG. 1. Region 208 of the image 200 includes chroma key colored pixels to indicate that this area of the image is transparent. In some cases, the background may be chroma key blue, chroma key green, “magic pink,” or any other appropriate color operable to indicate the transparent area of the image. The chroma key region 208 of the image may be replaced by a video feed or a graphic image by a compositing system such as a video switcher.

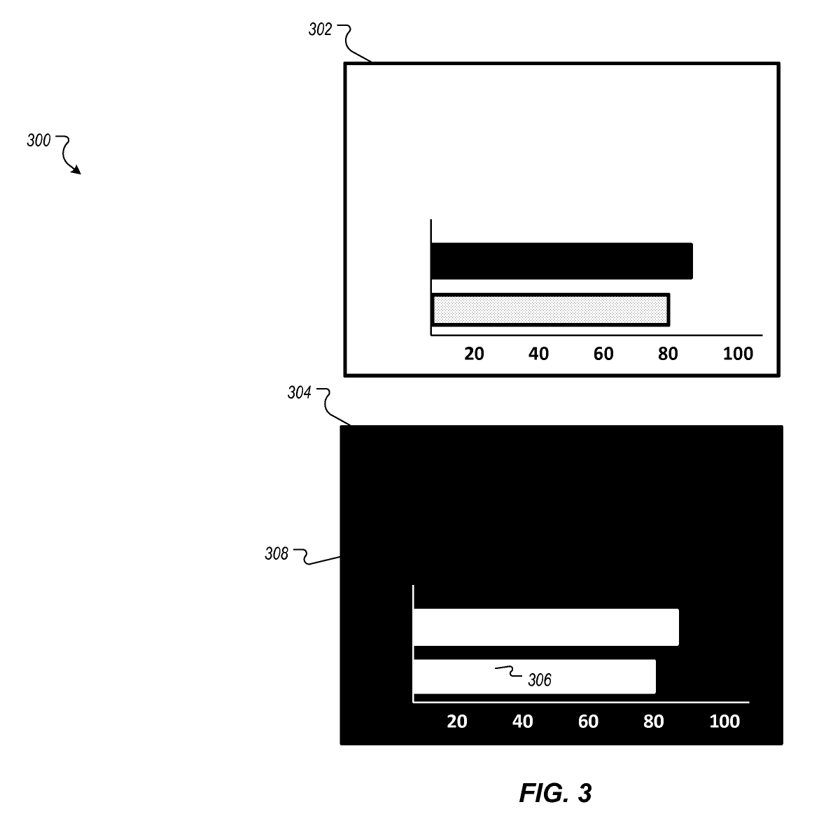

FIG. 3 shows an example image set 300 including an image 302 and associated alpha channel transparency information 304. The image set 300 can be included in a web page. The image set 300 can include the same or similar transparency information encoded by the chroma key region 208 of image 200 in FIG. 2, except the information is presented using an alpha channel. In this example, image 302 is identical to image 200 except that the chroma key region 208 is colored white (although any other color values can be used). The alpha channel 304 includes an opaque region 306, represented by the white portions, and a transparent portion 308, represented by the black portions. The alpha channel 304 is effectively a mask for image 302 indicating the portions covered by black are to be removed and portions covered by white should not be removed. In some cases, the alpha channel 304 may encode multiple levels of transparency. For example, the alpha channel 304 may include a gray area indicating that the area of the image covered by that portion of the channel should be fifty percent transparent. The alpha channel 304 may define as many such levels of transparency as are necessary for the image 302.

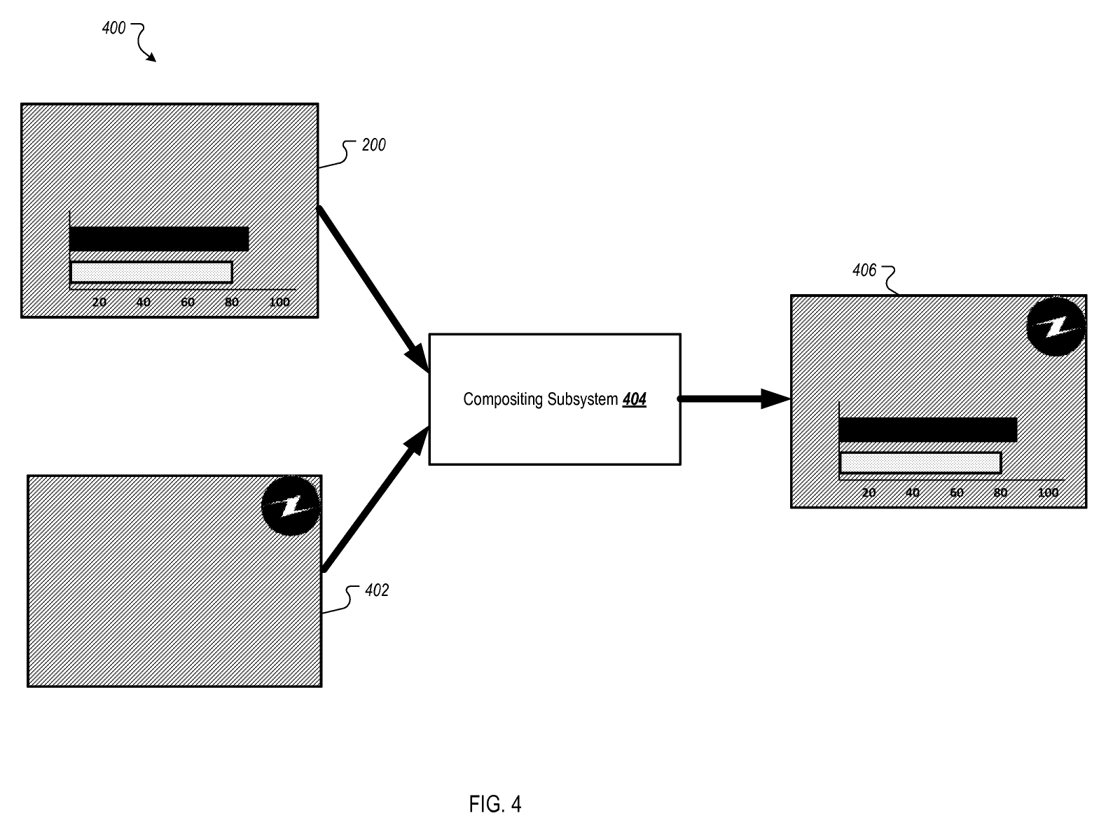

FIG. 4 is an illustration of a compositing process 400 involving two graphics encoded with chroma key transparency information. In the illustrated example, graphics elements 200 and 402 are fed to a compositing subsystem 404. The compositing subsystem 404 combines the two images according to the transparency information and produces composite image 406 including the image data from both images. In some cases, the compositing subsystem 404 includes a video switcher such as the video switcher 150 described relative to FIG. 1. In other cases, the compositing subsystem 404 includes the graphic processing system 102 described relative to FIG. 1. In some instances, the composite image 406 may include chroma key information indicating transparent regions (as shown) so that the composite image may be fed to additional systems for further compositing, such as with a video feed. In other instances, the composite image 406 may not include transparency information.

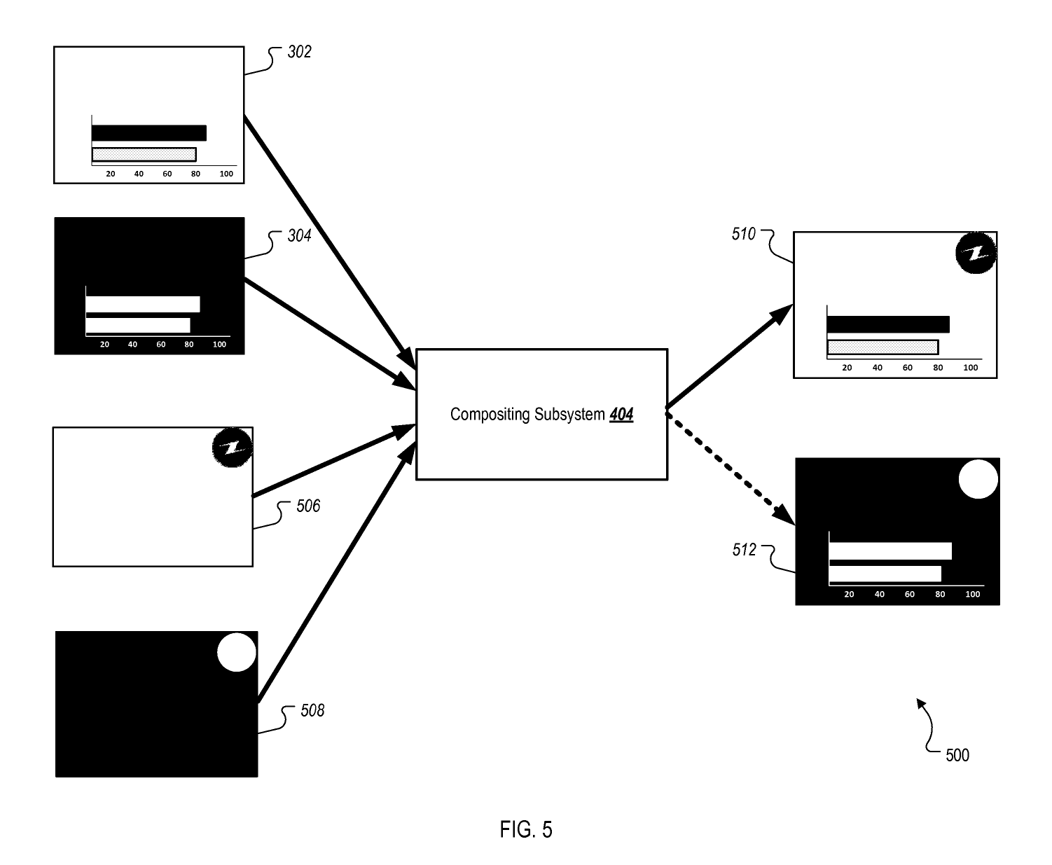

FIG. 5 is an illustration of a compositing process 500 involving two graphics 302 and 506 with associated alpha channel transparency information 304 and 508. In the illustrated example, graphics element 302 and 506 are fed to a compositing subsystem 404. The compositing subsystem 404 combines the two images according to the transparency information encoded in the alpha channels 304 and 508 and produces composite image 510 including the image data from both images. In some cases, the compositing subsystem 404 also produces composite alpha channel 512 including the alpha channel information from both alpha channels 304 and 508. In other cases, the compositing subsystem 404 produces composite image 510, which can include background video or graphics (not shown), such that the composite image 510 is in a form that is ready for broadcast (e.g., multiple layers are flattened into a composite video).

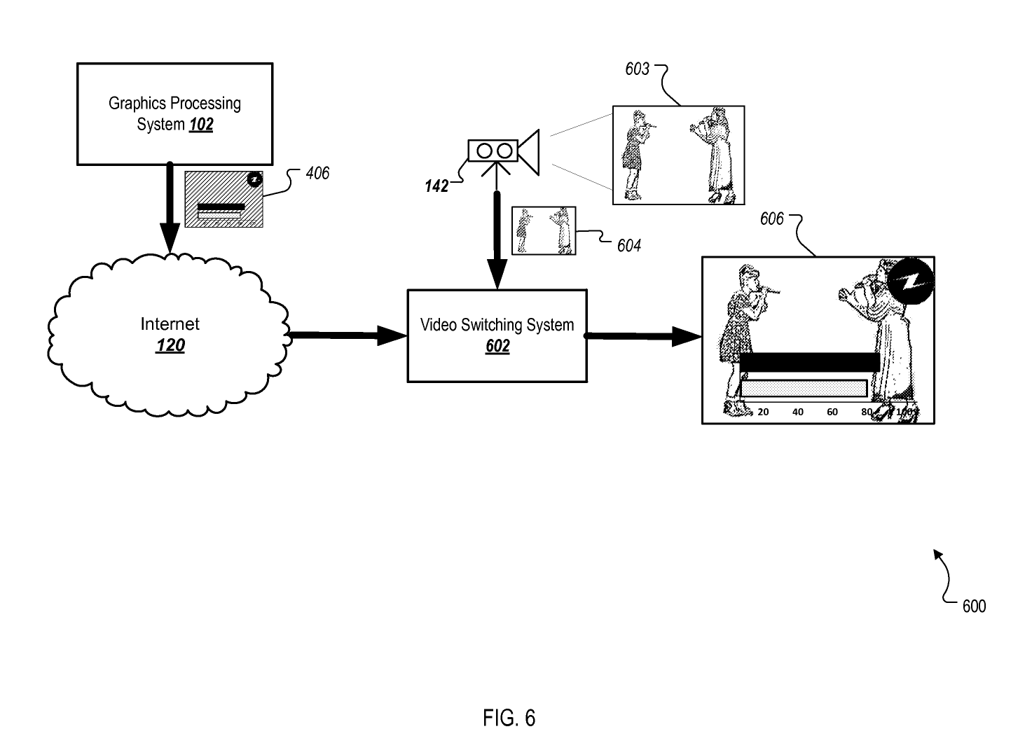

FIG. 6 is a functional block diagram 600 illustrating the compositing of chroma key encoded graphic data 406 from the Internet 120 with live video data. In the illustrated implementation, the graphics processing system 102 provides the chroma key encoded graphics data 406 to the video switching system 602 over the Internet 120. The video switching system 602 may be a single component or may contain multiple distinct components. In some implementations, the video switching system 602 includes the broadcast graphics system 140 and the video switcher 150 described in FIG. 1. In some cases, the video switching system 602 may request, retrieve, or receive the graphics data 406 from the graphics processing system 102 by any of the mechanisms discussed relative to FIG. 1, or by any other suitable mechanism. In other cases, the graphics data 406 may be replaced with full motion video data.

The video switching system 602 may also receive a live video feed 604 from camera 142 of scene 603. The video switching system 602 may then composite the video feed 604 into the graphic element 406 using the chroma key transparency information encoded in the graphic element 406. In some cases, the video switching system 602 performs this compositing by replacing the chroma key color with the video feed 604. In some cases, the graphic element 406 is provided to the video switching system 602 in a format, resolution, and aspect ratio to allow it to be composited with a video feed without having to convert the graphics data. In other cases, the video switching system 602 may perform additional format changes, protocol conversion, transcoding, aspect ratio changes, or any other processing necessary in compositing the video feed 604 and the graphic element 406. The video switching system 602 may then produce composite video feed 606 including the live video feed 604 overlaid by the graphic element 406. In some cases, this composite video feed 606 is then passed to a television distribution system for broadcast. In some implementations, the video feed 606 can be pre-recorded video provided by a playback server as opposed to a live video feed.

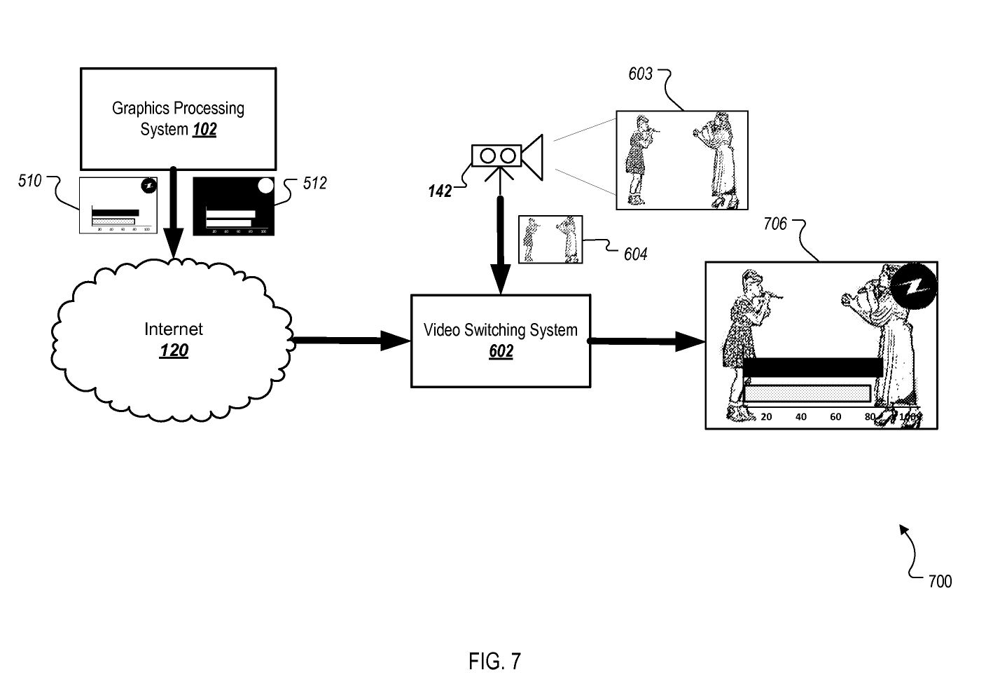

FIG. 7 is a functional block diagram 700 illustrating the compositing of alpha channel encoded graphic data 510 and 512 from the Internet 120 with live video data. In the illustrated implementation, the graphics processing system 102 provides the alpha channel encoded graphic data 510 and the alpha channel information 512 to the video switching system 602 over the Internet 120. The video switching system 602 may also receive a live video feed 604 from camera 142 of scene 603. The video switching system 602 may then composite the video feed 604 into the graphic element 510 using the alpha channel information 512. The video switching system 602 may also perform additional format changes, protocol conversion, transcoding, aspect ratio changes, or any other processing necessary in compositing the video feed 604 and the graphic element 406. The video switching system 602 may then produce composite video feed 706 including the live video feed 604 overlaid by the graphic element 510. In some cases, this composite video feed 606 is then passed to a television distribution system for broadcast. In some implementations, the video feed 706 can be pre-recorded video provided by a playback server as opposed to a live video feed.

FIG. 8 is an illustration of an administration interface 800 for controlling a live voting application. In some cases, the administration interface 800 is a web page provided by the graphics processing system 102. The administration interface 800 may also be a stand-alone application running on a user device and communicating with an external system such as the graphics processing system 102. An administrator may fill out the various fields in the administration interface 800 to specify various configuration attributes associated with the associated application. In some cases, the administration interface will control the presentation of voting options and results data to the users of the voting application on individual end user devices.

In the illustrated implementation, new question button 804 allows the administrator create a new poll question to be asked in the voting application. In some cases, an administrator clicking this button will clear all fields on the administration interface 800 and the administrator will have to specify answers for the new question. The administration interface 800 may also include a list of all previously created questions and allow the administrator to select and modify previous questions. Question box 802 allows the administrator to enter question text to appear in the voting application. In some cases, this text will appear exactly as typed on a user's device to instruct the user to vote. The question box 802 may also include formatting options for the administrator to control the appearance of the text, such as the font, style, color and other attributes. Edit button 806 allows the administrator to edit a previously created poll.

As illustrated, the poll type radio buttons 808, 810 and 812 allow the administrator to select between different poll graph templates (e.g., mock-ups of poll results graphs). In the illustrated case, the administrator may choose between the two-bar poll option 808, the three-bar poll option 810, and the four-bar poll option 812. In some cases, additional poll types may be available for selection such as pie charts, line graphs, and other types.

The administration interface 814 may also include a sponsor text box 814 in which the administrator may enter the name or other information about an advertiser or other entity that has chosen to sponsor of this poll. In some cases, the sponsor text box 814 may be replaced with a drop down list of current sponsors from which the administrator can select a sponsor for the poll. In addition, the administration interface 814 may allow the administrator to upload, select, or otherwise identify a graphic, video, or other visual feature associated with the sponsor to be displayed along with the poll and/or poll results.

The administration interface 800 may also include text boxes 816 and 818 allowing the administrator to specify labels for the two values shown in the results chart. In some cases, more than two boxes may be presented allowing for additional values to be shown. The point value boxes 820 and 824 may allow the administrator to specify the number of points that should be added or subtracted from the associated point total for each vote cast. Each of the text boxes is also associated with a Twitter hashtag text box (822 and 826) that allows the administrator to enter the text of a hashtag Twitter users may use to vote for the associated option. The system may monitor Twitter for tweets containing the specified hashtag, and may count each tweet as one vote for the option associated with the hashtag. The administration interface may also contain a submit button 828 that will send the data entered into the interface to an external system (such as graphic processing system 102) so it can be applied.

The administration interface 800 also includes a preview 830 showing the results of the current question. In some cases, the preview 830 uses actual live data received from the user devices in response to the question to generate the graph and can also show the numerical values of the data in addition to a graphical representation of the live results. The preview 830 may also use dummy data in order to provide a mock-up of how the results chart will look on a user's device. In the depicted example, the bar 832 of preview 830 shows the votes for “Yes,” while bar 834 shows the votes for “No.” The preview 830 also includes an option selection box 836 showing the options that will be presented to a user, and a submit button 838.

In some cases, the administration interface 800 may allow the administrator to control not only the question that is presented on the user device, but also the layout of the results included in the linear television broadcast. In such cases, the administrator's entries in the boxes specifying attributes of the chart would be reflected in the video associated with the broadcast. Users voting on the user devices may be able to see the results changing in near real-time in response to their votes and the votes of other users.

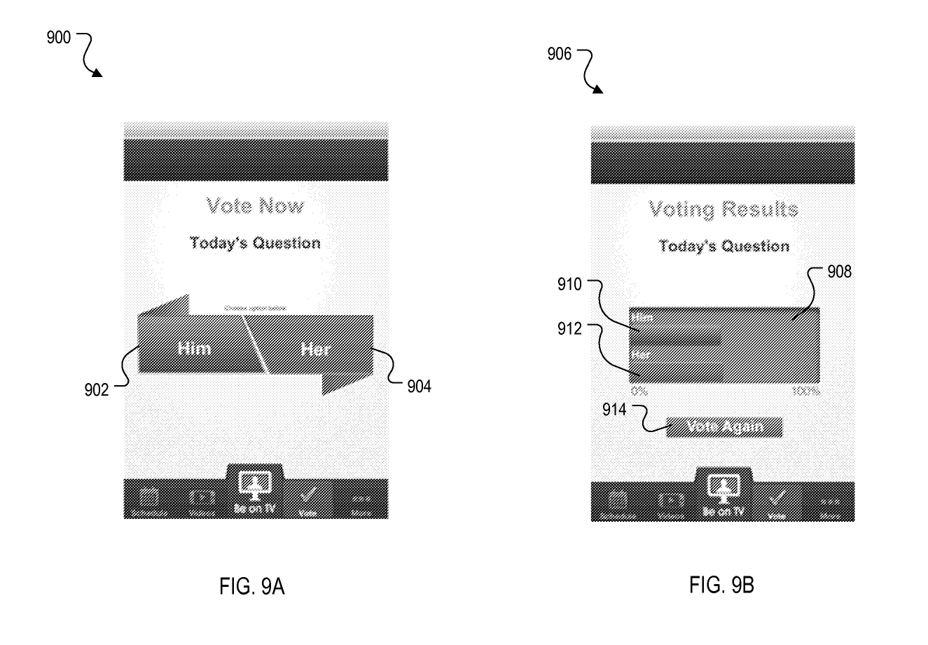

FIG. 9A is an illustration of a user interface 900 for a live voting application presented on a user device. In the depicted implementation, the interface 900 presents the user with a question and two options: “him” option 902 and “her” option 904. The user may choose one of these two options. In some cases, after choosing one of the options the user may be presented with a results screen such as that presented in FIG. 9B. In some cases, the interface 900 is presented by a software application executing on a user device. The interface 900 may also be a web page presented by a remote server.

FIG. 9B is an illustration of a user interface 906 for the live voting application showing voting results. The depicted user interface 906 includes a results chart 908 charting the votes for the “him” and “her” options. Illustrated bar 910 corresponds to votes for the “him” option, while bar 912 corresponds to the “her” option. The user interface 906 can be dynamically generated based on user input received from a plurality of user devices and can further include other content identified for each user device (e.g., based on the vote submitted by the user device, the location of the user device, or user profile information associated with the user device). The user interface 906 may also include a “vote again” button 914 that the user may select to cast an additional vote. In some cases, selecting the “vote again” button 914 may return the user to the user interface 900 shown in FIG. 9A.

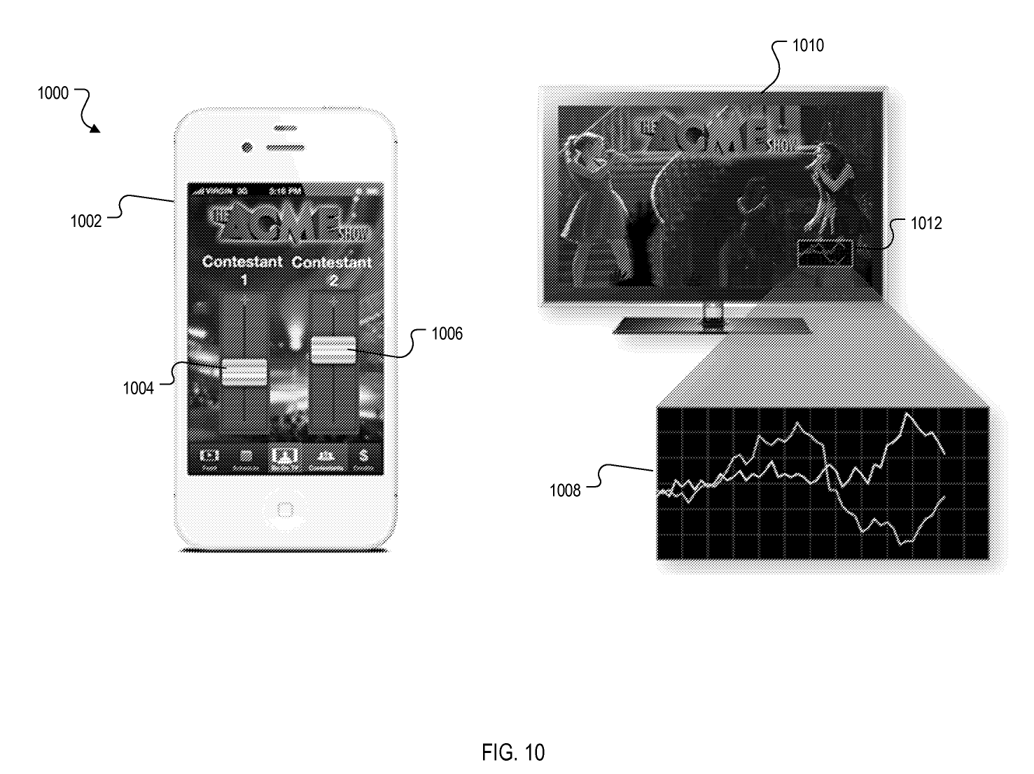

FIG. 10 is an illustration a live voting system 1000 including a live voting application and associated voting results shown on a linear television broadcast 1010. The system 1000 may include a smartphone running a live voting application 1002. Alternatively or in addition, the live voting application 1002 may include sliders 1004 and 1006 each associated with a candidate shown in the linear television broadcast 1010. A user of the voting application 1002 may actuate these sliders to show their current level of approval for each of the contestants. For example, the user may move the sliders 1004 and 1006 towards the top of the application 1002 to indicate that the associated contestant is performing well, and may move the sliders toward the bottom of the application to indicate that the associated contestant is performing poorly. The voting application 1002 sends this voting data periodically (or in real-time as user input or changes thereto is received) to a server (e.g., the dynamic data server 106 of FIG. 1) where the user's data is aggregated with other users of the application. A graphic element 1012 representing the aggregated voting results may be composited into the linear television broadcast 1010 as shown. The illustrated graphic element 1012 shows the aggregated user response to each of the contestants in linear television broadcast 1010 plotted over time. The illustrated larger representation 1008 of the graphic element 1012 shows that the graphic contains a line associated with each contestant showing the contestant's approval rating over time. As discussed previously, this graphic element 1012 may be dynamically generated by the graphics processing system 102 (specifically by the dynamic data server 106 and the graphics content server 104) and incorporated into an image that includes transparency information. A web page that includes the graphic with associated transparency information can then be fed from the web server 114 to the television production or broadcast facility 138 for compositing with the linear television broadcast 1010, which can then be broadcast using television broadcast distribution systems.

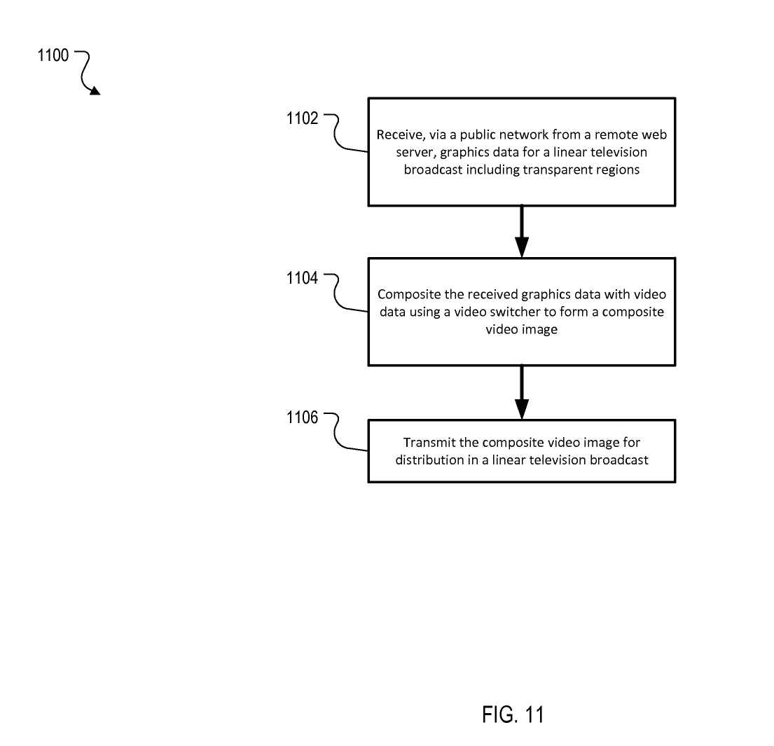

FIG. 11 is a flowchart illustrating a method 1100 for distributing content over a public network for inclusion in a linear television broadcast. At 1102, graphics data (i.e., included in a web page that defines the visual appearance of graphics to be presented) for a linear television broadcast is received from a remote web server via a public network. The graphics data includes transparent regions specified by chroma key coloring, an alpha channel, or by any other suitable mechanism. The graphics data may be received according to the techniques discussed relative to FIG. 1 for the communication between the graphics processing system 102 and the broadcast graphics system 140.

At 1104, the received graphics data is composited with video data using a video switcher to form a composite video image. In some cases, the compositing is performed by replacing the transparent regions of the graphics data with video data from another source, as described previously. At 1106, the composite video is transmitted for distribution in a linear television broadcast. This transmission may include sending the composite video to a television distribution system such as that described in FIG. 1.

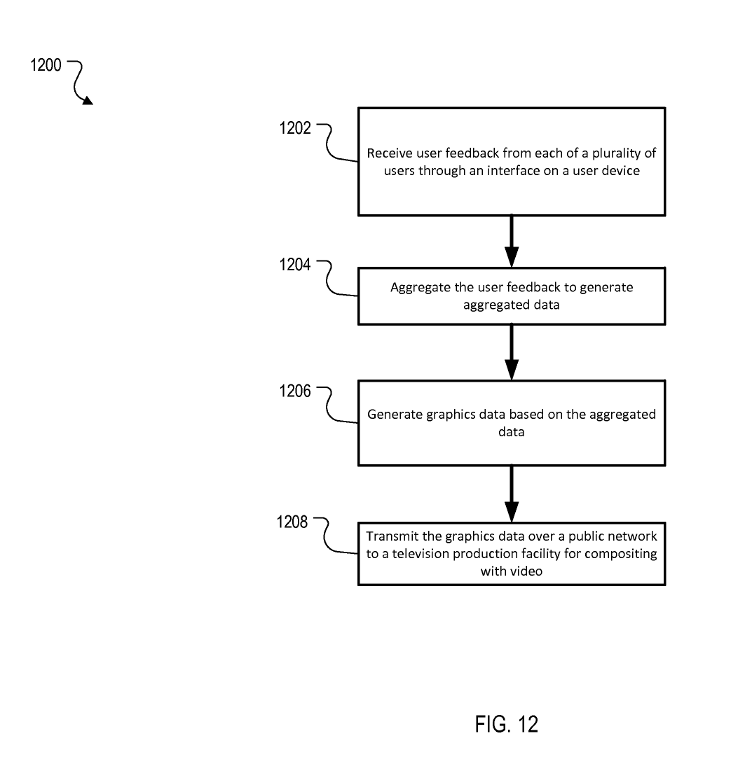

FIG. 12 is a flowchart illustrating a method 1200 for receiving and presenting user feedback associated with a linear television broadcast. At 1202, user feedback is received from each of a plurality of users through an interface of a user device. In some cases, this interface may be the interface 900 from FIG. 9A, the interface 1002 from FIG. 10, or any other suitable interface. The feedback may be received over a network such as the Internet, or any other public or private network. At 1204, the user feedback is aggregated to generate aggregated data. In some cases, this is performed by the dynamic data server 106 of the graphics processing system 102. At 1206, graphics data is generated based on the aggregated data. In some cases, the generated graphics data may be a bar graph, a pie chart, a line graph, a heat chart, or any other graphic representation suitable to convey the aggregated data. At 1208, the graphics data is transmitted over a public network to a television production or broadcast facility for compositing with video.

No particular computer architecture is intended to be implied by this example. The example is intended to be representative generally of computing systems suitable for being programmed to perform these processes, and not limiting. Execution of a process need not be limited to a single computing system, but could be distributed among more than one computing system. Programs running on a computing system or on multiple computing systems execute parts of the process described in the flow diagrams of FIGS. 11 and 12. Multiple instances of a process may execute on the same or on multiple different computing systems. Instances of each of the servers described above and depicted in the various figures could run on the same computer or on different virtual machines on the same computer.

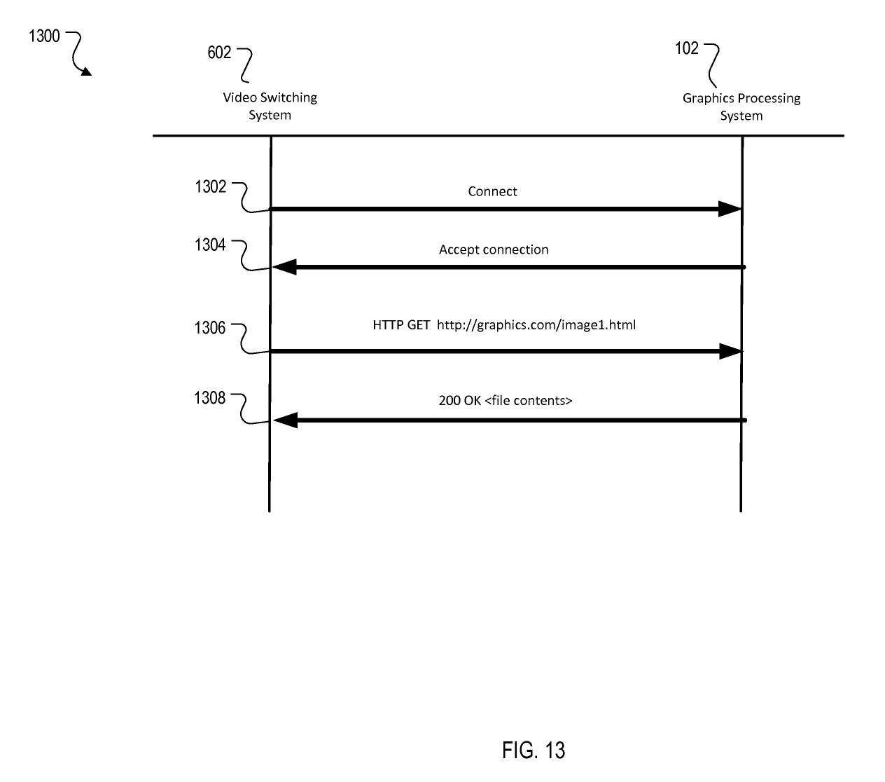

FIG. 13 is a diagram illustrating an example interaction 1300 between the video switching system 602 and the graphics processing system 102. In the depicted interaction, the video switching system 602 requests graphics for inclusion in a linear television broadcast from the graphics processing system 102. As discussed previously, in other implementations, the video switching system 602 and the graphics processing system 102 may interact in different ways to perform this function, such as the graphics processing system 102 pushing graphics data to the video switching system 602 or the graphics processing system 102 updating a database with the graphics data. The depicted interaction is thus one example of the interaction between these components and is not intended to limit the scope of the present disclosure.

At 1302, the video switching system 602 sends a connect request to the graphics processing system 102. In some instances, this connect request will be sent over a network using the Transport Control Protocol (TCP). In implementations using a connectionless protocol (such as Universal Datagram Protocol or “UDP”), the connect request may be omitted. The connect request may also be associated with a manual connection activity performed by a user, such as logging in or accessing the graphics processing system 102.

At 1304, the graphics processing system 102 sends an accept connection message to the video switching system 602. In some implementations, the accept connection message indicates that a connection has been established between the graphics processing system 102 and the video switching system 602. In the case that the graphics processing system 102 does not accept the connection, this message may be replaced with a reject connection message or another type of negative acknowledgement. Again, in connectionless implementations, this step may be omitted.

At 1306, the video switching system 602 sends the graphics processing system 102 a request for a specific resource. In the depicted implementation, the request is an “HTTP GET” message formatted according to the Hypertext Transfer Protocol (HTTP). The request specifies the URL “http://graphics.com/image1.html.” Although the depicted URL refers to an HTML page, the URL may also refer to any other resource, including, but not limited to, image resources video resources, or database resources. In other implementations, the communication at 1306 may occur over any other suitable protocol including, but not limited to, Simple Object Access Protocol (SOAP), FTP, RPC, or any other suitbale protocol. The request may also include additional parameters in addition to the URL, such as, for example, an aspect ratio or resolution of a requested resource.

At 1308, the graphics processing system 102 sends the video switching system 602 a response including the contents of the requested resource. In the depicted implementation, these contents may include an HTML page including graphics for inclusion in a linear television broadcast. In other instances, the contents of the response may include the requested resource in its native format. The response may also be formatted according to any appropriate protocol, such as those described with respect to the request at 1306.

In some instances, if an HTML page is returned in the response including tags indicating that the page should include images or other additional resources, the video switching system 602 may perform additional HTTP GET requests for these additional resources using the associated URLs specified in the HTML page. In some cases, these subsequent requests are sent using the same connection as the first request, and thus the actions at 1302 and 1304 need not be repeated. The subsequent requests may also be sent using a new connection, necessitating the repetition of the actions at 1302 and 1304.

Implementations of the present disclosure and all of the functional operations provided herein can be realized in digital electronic circuitry, or in computer software, firmware, or hardware, including the structures disclosed in this specification and their structural equivalents, or in combinations of one or more of them. Implementations of the invention can be realized as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter affecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclose can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices, magnetic disks, e.g., internal hard disks or removable disks, magneto optical disks and CD ROM and DVD-ROM disks. The processor and the memory can be supplemented by, or incorporated in, special purpose logic circuitry.

To provide for interaction with a user, implementations of the invention can be implemented on a computer having a display device, e.g., a CRT (cathode ray tube) or LCD (liquid crystal display) monitor for displaying information to the user and a keyboard and a pointing device, e.g., a mouse or a trackball, by which the user can provide input to the computer. Other kinds of devices can be used to provide for interaction with a user as well, for example, feedback provided to the user can be any form of sensory feedback, e.g., visual feedback, auditory feedback, or tactile feedback and input from the user can be received in any form, including acoustic, speech, or tactile input.

Implementations of the present disclosure can be realized in a computing system that includes a back end component, e.g., as a data server, or that includes a middleware component, e.g., an application server, or that includes a front end component, e.g., a client computer having a graphical user interface or a Web browser through which a user can interact with an implementation of the present disclosure, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this disclosure contains many specifics, these should not be construed as limitations on the scope of the disclosure or of what may be claimed, but rather as descriptions of features specific to particular implementations of the disclosure. Certain features that are described in this disclosure in the context of separate implementations can also be provided in combination in a single implementation. Conversely, various features that are described in the context of a single implementation can also be provided in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the present disclosure have been described. Other implementations are within the scope of the following claims. For example, the actions recited in the claims can be performed in a different order and still achieve desirable results.

What is claimed is:

1. A method comprising:
receiving, via a network from a remote web server, a web page defining a plurality of pixels for presentation in a linear television broadcast, wherein the web page includes graphics data for inclusion in the linear television broadcast, and data defining one or more transparent regions;
compositing the received web page, based on the one or more transparent regions, with video from at least one other channel using a video switcher at a television production or television broadcast facility to form a composite video image; and
transmitting the composite video image for distribution in a linear television broadcast.

2. The method of claim 1 wherein the web page includes formatting information specifying a position and orientation at which the graphics data should be included in the linear television broadcast.

3. The method of claim 1 wherein the formatting information is defined by a markup language code.

4. The method of claim 1 wherein the web page includes one or more dynamic elements operable to display updated information from the remote web server without the web page being refreshed.

5. The method of claim 1 further comprising rendering the received web page by a web browser prior to the compositing the received web page with video.

6. The method of claim 1 wherein the graphics data includes an alpha channel defining the one or more transparent regions.

7. The method of claim 1 wherein the graphics data includes chroma key data defining the one or more transparent regions.

8. The method of claim 1 wherein the graphics data defines graphics formatted according to a first resolution of the linear television broadcast, the method further comprising receiving a second web page including graphics data defining graphics formatted according to a second resolution of a linear television broadcast.

9. The method of claim 1 further comprising:
receiving, via the network from at least one remote web server, a plurality of web pages, wherein each web page includes graphics data for inclusion in the linear television broadcast and data defining one or more transparent regions; and
compositing the received web pages, based on the one or more transparent regions, with each other and with video from at least one other channel using a video switcher to form the composite video image.

10. The method of claim 1 further comprising capturing at least a portion of the video from the at least one other channel concurrently with receiving at least a portion of the graphics data via the network from the remote web server.

11. The method of claim 1 further comprising sending a request for the graphics data to the remote web server using a web address associated with the graphics data.

12. The method of claim 11 wherein the request for graphics data includes a uniform resource locator for the web page.

13. The method of claim 11 wherein the request for graphics data is sent by the video switcher using an application programming interface associated with the remote web server.

14. The method of claim 1 further comprising:
receiving, at the remote web server via a public network, input from a plurality of user devices; and
generating at least a portion of the graphics data based on the input received from the plurality of users.

15. The method of claim 14 further comprising:
generating additional graphics data defining graphics for presentation on user devices, wherein the additional graphics data is based on the input received from the plurality of users and includes content substantially similar to the graphics data included in the web page composited into the composite video image;
identifying additional content for presentation on each of the plurality of user devices, wherein the additional content for each user device is identified based on metadata associated with the user device; and
transmitting the additional graphics data and the identified additional content to each of the plurality of user devices for display on the user devices.

16. The method of claim 14 wherein the input from the plurality of user devices is received in response to information presented in the linear television broadcast.

17. The method of claim 14 wherein the input from each of the plurality of user devices is received in response to information received by the user device for presentation on the user device.

18. The method of claim 17 wherein the information received by the user device is received from a server system associated with the remote web server.

19. The method of claim 18 wherein the information received by the user device is defined through an administrator interface associated with the server system.

20. The method of claim 17 further comprising providing the graphics data to each of the plurality of users.

21. The method of claim 1 wherein the graphics data includes dynamic data generated based on feedback from viewers of the linear television broadcast.

22. The method of claim 1 wherein the graphics data is based at least in part on input received through an administrator interface associated with the remote web server.

23. A computer storage medium encoded with a computer program, the program comprising instructions that when executed by data processing apparatus cause the data processing apparatus to perform operations comprising:
receiving user feedback from each of a plurality of users in response to information presented on a respective user device, wherein the user feedback is provided through an interface on the user device;
aggregating the user feedback to generate aggregated data;
generating graphics data based at least in part on the aggregated data, wherein the graphics data includes data defining one or more transparent regions; and
transmitting the graphics data over a network to at least one of a television production facility or a television broadcast facility for compositing the graphics data with video.

24. The computer storage medium of claim 23 wherein the instructions, when executed by data processing apparatus cause the data processing apparatus to perform operations comprising transmitting the information presented on the respective user devices to each of the user devices.

25. The computer storage medium of claim 23 wherein the instructions, when executed by data processing apparatus cause the data processing apparatus to perform operations comprising transmitting the graphics data over a network to each of a plurality of television production facilities or television broadcast facilities for compositing the graphics data with video.

26. The computer storage medium of claim 23 wherein the instructions, when executed by data processing apparatus cause the data processing apparatus to perform operations:
generating a plurality of different versions of the graphics data; and
transmitting one of the plurality of different versions of the graphics data to a corresponding television production facility or television broadcast facility for compositing the graphics data with video.

27. The computer storage medium of claim 26 wherein each of the plurality of different versions of the graphics data is associated with a different uniform resource locator and the version transmitted to each television production facility or television broadcast facility is selected based on a uniform resource locator request received from the television production facility.

28. A system comprising:
a graphics server adapted to receive a web page including graphics data from a web server via a network, wherein the graphics data includes data defining one or more transparent regions;
a video switcher having a plurality of input channels including:
a first input channel for receiving the graphics data from the graphics server; and
a second input channel for receiving video data;
wherein the video switcher is adapted to generate a composite video image based on the video data and the graphics data using the data defining the one or more transparent regions of the graphics data; and
a transmission channel for transmitting the composite video image for inclusion in a linear television broadcast.

29. The system of claim 28 wherein the video switcher further includes a third input channel adapted to receive additional graphics data from the graphics server.

30. The system of claim 28 further comprising the web server, wherein the web server is adapted to generate the graphics data based on feedback received from viewers of the linear television broadcast.
